(19) United States
(12) Patent Application Publication
(10) Pub. No.: US 2007/0088843 A1
(43) Pub. Date: Apr. 19, 2007

(54) EZ SAVE MUSIC LIBRARY

(75) Inventor: Robert Joseph Normand, Big Pine Key, FL (US)

Correspondence Address: ROBERT JOSEPH NORMAND, 30312 PRINCE ROAD, BIG PINE KEY, FL, 33043-5118, US

(73) Assignee: Robert Joseph Normand, Big Pine Key, FL (US)

(21) Appl. No.: 11/163,369

(22) Filed: Oct. 17, 2005

(51) Int. Cl. G06F 15/16

(52) U.S. Cl. 709/231

(57) ABSTRACT

What is new in the art to which this invention pertains is the ability to safely multi-task while driving in your automobile, archiving music selections to your Internet account for retrieval in seconds from your personal computer. This is in stark contrast to the present methods of digital music search, retrieval and download, which are extremely time, consuming and cumbersome.

The “EZ Save” Music Library system consist of a single button, to be placed predominately on the face of all new satellite radio receivers. This button when pushed would capture the song currently being broadcast and save it to the subscribers personal web account. This song could then easily be downloaded to the user's personal computer, for rapid download to any music server for replay on demand.

This invention pertains to the field of personal digital music library search, download and interpolation into user devices for replay on demand.

As there presently exist a rapidly expanding satellite radio market providing a vast array of music, talk, news or sports selections the listener has nearly endless choices.

There also exist expanding demands for Internet downloadable, digital quality music, due in part to such phenomenon as the Apple IPOD portable music server or music servers in home, distributed audio systems. Users of these devices will typically access digital music selections from Internet sites and download them individually, paying Copyright fees per selection.

I find these technologies fascinating but there is a missing link, which presents itself in the light of today's hectic, time constrained lifestyles. If you presently download music from the Internet to your IPOD or music server, you must sit for extended times searching specific Genre, Artist and/or Titles prior to download, and this is only for those tracks which you are familiar with, or sitting even longer sampling new music in search of those tracks which suite your individual taste. This can be cumbersome, time consuming, and lead to procrastination when prioritizing valuable free time, thus not fully appreciating available technologies.

Further as most American workers spend on average one hour per day in their vehicles commuting to and from the workplace listening to radio while captive to that time and place. This time could safely be more productive with the “EZ Save” Music Library System.

This patent application is for a concept to improve upon an existing patent and/or patents. This concept would provide for the convergence of the satellite radio industry and the Internet music download industry, with intention upon expansion of legal sales of the musical art form and simplification and expedition for the user.

The “EZ Save” Music Library button as referenced in the above summary would be incorporated into all new satellite radio receivers, be they automotive, portable or stationary home units. The listener would press this button when he or she hears a song or other broadcast, such as a talk show, news broadcast or sports event of their preference.

The “EZ Save” button when activated would cause the receiver to save the selection using already existing song title identification technologies into its memory.

At some predetermined interval, the receiver would then send this archived selection via satellite uplink to a personal subscriber account site. This would require the upgrading of the present satellite radio systems from a one-way downlink only, to a two-way uplink/downlink system.

The satellite radio provider would need to upgrade their Website to provide a simple subscriber login service to access their personal subscriber account site.

Once the subscriber has accessed his or her personal account they would find the “EZ Save” Icon on their screen, and when they click on that Icon all of the songs or other broadcast which were saved while driving in their cars or hanging out at the beach would instantly be downloaded to their personal computers, for interpolation into the device of their choice for replay on demand

What is claimed is:

1. The concept of the production and use of an “EZ Save” button at the receiver or unit of broadcast for archiving broadcast selections.

2. The concept of the communication of the aforementioned archived broadcast selections from the receiver or unit of broadcast to a personal computer accessible account via satellite link.

3. The concept of the creation of an Internet accessible personal subscriber account with which to receive the aforementioned satellite communication from the original receiver of broadcast selections.

4. The use of the “EZ Save” Music Library Icon within the aforementioned Internet accessible personal subscriber account to download archived selections to the users personal computer for interpolation to any device of the users choice for replay on demand.
